(19) United States
(12) Patent Application Publication
(10) Pub. No.: US 2004/0072545 A1
(43) Pub. Date: Apr. 15, 2004

(54) Method of controlling transmission in a radio system

(76) Inventors: Jyri Hamalainen, Oulu (FI); Risto Wichman, Helsinki (FI); Juha Ylitalo, Oulu (FI)

Correspondence Address: SQUIRE, SANDERS & DEMPSEY L.L.P., 14TH FLOOR, 8000 TOWERS CRESCENT, TYSONS CORNER, VA, 22182, US

(21) Appl. No.: 10/467,999

(22) PCT Filed: Nov. 21, 2002
(86) PCT No.: PCT/FI02/00940

(30) Foreign Application Priority Data
Dec. 14, 2001 (FI) 20012473

(51) Int. Cl. H04B 1/02

(52) U.S. Cl. 455/101

(57) ABSTRACT

The invention relates to a method of controlling a radio system in a base transceiver station (204), in which base transceiver station (204) at least one antenna array is formed, which comprises at least two antennas (236, 238) for transmitting and receiving a signal, and in which method at least two antennas (236, 238) of each antenna array are arranged in such a way that antenna beams (410, 412) formed by the at least two antennas deviate vertically from each other what it comes to at least one property thereof. The antenna array can be controlled in a desired manner by controlling the ratio of the signal powers supplied to each antenna of the antenna array. The solution of the invention provides for instance flexibility for controlling signal power, which reduces interference in a radio system and increases data transmission capacity in a radio system.

### FIELD

The invention relates to a method and an apparatus implementing the method for controlling transmission in a radio system, comprising at least one base transceiver station connected to the terminals in its area.

### BACKGROUND

The present invention is applicable to any radio system, in particular to a cellular radio system utilizing wideband code division multiple access, WCDMA.

In the WCDMA method, a narrowband data signal is multiplied with a spreading code which is significantly more wideband than the data signal, whereby the information in the data signal spreads over the whole frequency band used. All terminals and base transceiver stations transmit the same frequency band simultaneously, and the connection between each terminal and base transceiver station is formed by using a separate spreading code for each terminal. The data signal is returned to the original band in the receiver by using the spreading code used in connection with transmission. In an ideal case, the signals that have been despread with another spreading code are neither correlated nor returned to the narrow band, but they can be seen as an increased noise level relative to the desired signal. This phenomenon is called multiple access interference, which is a significant factor limiting the data transmission capacity of a radio system.

Multiple access interference may be caused when a terminal transmitting at too great transmission power disturbs in the base transceiver station the reception of signals transmitted by other terminals in the area of its own cell or that of a neighbouring cell. Multiple access interference can also be caused by a base transceiver station. Such a situation arises when, for instance, one of the terminals of the base transceiver station cell requires great transmission power of the base transceiver station. The great transmission power is also directed at the terminals in the area of a neighbouring cell, which means that their interference level increases, whereby the base transceiver station of the cell in question attempts to compensate for this by increasing the transmission power. The increased transmission power, in turn, causes interference in neighbouring cells, and thus the multiple access interference causes problems at radio network level.

On the basis of the multiple access interference mechanisms described above, the magnitude of the multiple access interference in a radio system depends on how well the signal power between the base transceiver station and the terminals can be allocated spatially. In solutions according to the prior art, the capability of terminals to allocate a radio signal is limited, and allocating the signal power takes mainly place in base transceiver stations.

In the solutions according to the prior art, allocation of the signal power is implemented by antenna beams. Formation of antenna beams is implemented with antennas formed of one or more elementary antennas, the form and direction of the beam structure being determined by the signal power supplied to each elementary antenna and by the phase shift between the signals. A typical base transceiver station comprises two or more separate antennas that form a horizontal beam structure.

It has been observed that directing antenna beams also vertically allows the multiple access interference between adjacent cells to be controlled significantly. In solutions according to the prior art, the vertical direction of one or more antenna beams directed horizontally in the base transceiver station is set the same at the installation stage of the antenna, for instance in the position determined by field measurements, or the common direction of the antenna beams is controlled mechanically by means of motors. This type of vertical direction is also called down-tilting. A drawback of fixed direction is that radio systems have a low ability to dynamically allocate signal power to required objects. Motorized direction allows the common direction of beams to be changed dynamically, whereby crosstalk of the cells determined by the beams can be controlled. Drawbacks of motorized direction include the high costs of motors and the electronics and mechanics relating to their use and control as well as their limited lifetime.

### BRIEF DESCRIPTION

An object of the invention is to provide an improved method of a cellular radio system for increasing data transmission capacity, and an apparatus implementing the method. This is achieved with a method of controlling a radio system in a base transceiver station, in which base transceiver station at least one antenna array is formed, which comprises at least two antennas for transmitting and receiving a signal, and in which method at least two antennas of each antenna array are arranged in such a way that antenna beams formed by the at least two antennas deviate vertically from each other what it comes to at least one property thereof. The method according to the invention is characterized by controlling the ratio of the signal powers transmitted via the different antennas of each antenna array.

Another object of the invention is a radio system implementing the method, comprising at least one terminal and at least one base transceiver station, the base transceiver station comprising at least one antenna array, which antenna array comprises at least two antennas, the antennas being arranged to form antenna beams deviating vertically from each other what it comes to at least one property thereof. A radio system according to the invention is characterized in that it comprises means for controlling the ratio of the signal powers transmitted via the different antennas of each antenna array.

Preferred embodiments of the invention are described in the dependent claims.

The invention is based on the antennas of the antenna array being arranged in such a way that the beams formed by them may deviate from each other as regards their vertical properties, which include the directional angle and shape, for instance. The antenna array can be controlled in a desired manner by controlling the ratio of the signal powers supplied to each antenna of the antenna array.

A plurality of advantages is achieved with the solution according to the invention. An essential advantage is that flexibility is achieved for controlling signal power, which reduces interference in a radio system and increases data transmission capacity in a radio system.

### LIST OF FIGURES

The invention will now be described in more detail in connection with preferred embodiments, with reference to the attached drawings, of which

FIG. 1 shows a simplified block diagram of a telecommunications system;

FIG. 2a shows a second simplified block diagram of a telecommunications system;

FIG. 2b shows an antenna array;

FIG. 2c shows an antenna array;

FIG. 3 shows a diagram of a radio system; and

FIGS. 4a to 4f show antenna beam structures according to the invention.

### DESCRIPTION OF THE INVENTION

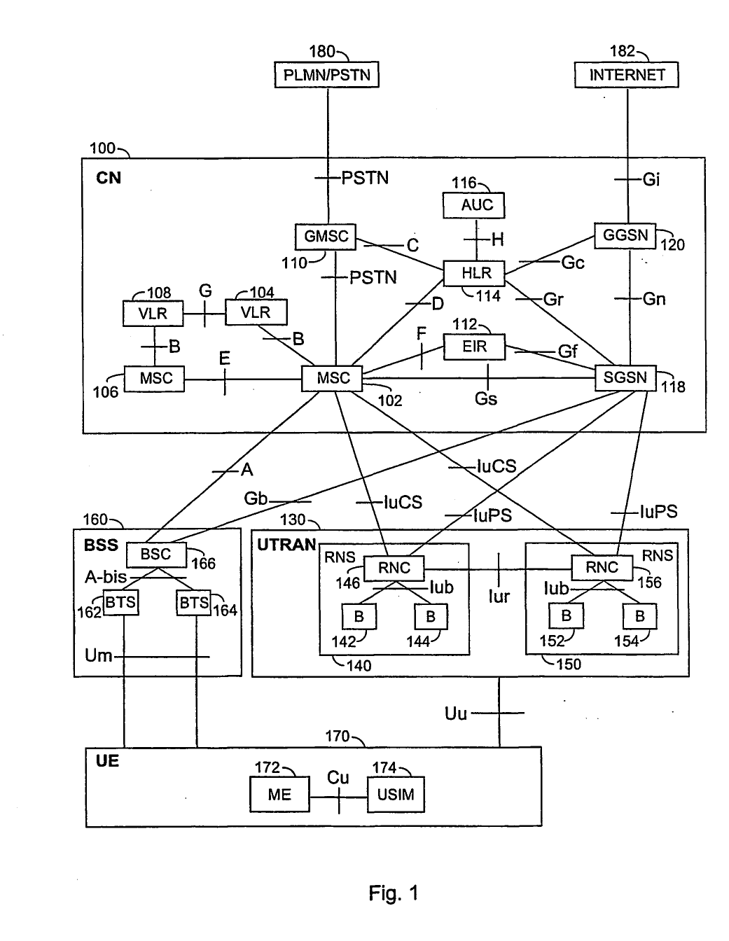

Since radio systems of the second generation (2G) and radio systems of the third generation (3G) and different combinations thereof, in other words radio systems of what is called the 2.5 generation, are in worldwide use and continuously under development, the embodiments are described in a radio system shown by FIG. 1, which comprises network elements of different generations in parallel. In the description, the 2G radio system is represented by the GSM (Global System for Mobile Communications), the 3G radio system being represented by a radio system based on the GSM-and utilizing the EDGE technology (Enhanced Data Rates for Global Evolution) for increasing data transmission speed, which radio system can also be used for implementing packet transmission in the GPRS system (General Packet Radio System), which represents the 2.5G radio system in its present form. The 3G radio system is also represented by systems known at least by names IMT 2000 (International Mobile Telecommunications 2000) and UMTS (Universal Mobile Telecommunications System). However, the embodiments are not limited to these systems, which are described merely as examples, but a person skilled in the art can apply the teachings to other radio systems including corresponding properties.

FIG. 1 is a simplified block diagram showing the most important parts of a radio system and interfaces between them at network element level. The structure and functions of the network elements are not described in detail, because they are generally known.

The main parts of a radio system are a core network (CN) 100, a radio access network 130 and user equipment (UE) 170. The term UTRAN is short for UMTS Terrestrial Radio Access Network, i.e. the radio access network 130 belongs to the third generation and is implemented by wideband code division multiple access (WCDMA) technology. FIG. 1 also shows a base transceiver station system 160, which is implemented by time division multiple access (TDMA) technology.

On a general level, the radio system can also be defined to comprise one or more units of user equipment, which is also known as a subscriber terminal and mobile phone, for instance, and a network part, which comprises the fixed infrastructure of the radio system, i.e. the core network 100, radio access network 130 and base transceiver station system 160.

The structure of the core network 100 corresponds to a combined structure of the GSM and GPRS systems. The GSM network elements are responsible for establishing circuit-switched connections, and the GPRS network elements are responsible for establishing packet-switched connections, some of the network elements being, however, in both systems.

A mobile services switching centre (MSC) 102 is the centre point of the circuit-switched side of the core network 100. The same mobile services switching centre 102 can be used to serve the connections of both the radio access network 130 and the base transceiver station system 160. The tasks of the mobile services switching centre 102 include: switching, paging, user equipment location registration, handover management, collection of subscriber billing information, encryption parameter management, frequency allocation management, and echo cancellation.

The number of mobile services switching centres 102 may vary: a small network operator may only have one mobile services switching centre 102, but in large core networks 100, there may be several. FIG. 1 shows a second mobile services switching centre 106, but its connections to other network elements are not shown to keep FIG. 1 sufficiently clear.

Large core networks 100 may have a separate gateway mobile services switching centre (GMSC) 110, which takes care of circuit-switched connections between the core network 100 and external networks 180. The gateway mobile services switching centre 110 is located between the mobile services switching centres 102, 106 and the external networks 180. The external network 180 can be for instance a public land mobile network (PLMN) or a public switched telephone network (PSTN).

A home location register (HLR) 114 contains a permanent subscriber register, i.e. the following information, for instance: an international mobile subscriber identity (IMSI), a mobile subscriber ISDN number (MSISDN), an authentication key, and when the radio system supports GPRS, a packet data protocol (PDP) address.

A visitor location register (VLR) 104 contains roaming information on user equipment 170 in the area of the mobile services switching centre 102. The visitor location register 104 contains almost the same information as the home location register 114, but in the visitor location register 104, the information is kept only temporarily.

An equipment identity register (EIR) 112 contains the international mobile equipment identities (IMEI) of the user equipment 170 used in the radio system, and a so-called white list, and possibly a black list and a grey list.

An authentication centre (AuC) 116 is always physically located in the same place as the home location register 114, and contains a subscriber authentication key Ki and a corresponding IMSI.

The network elements shown in FIG. 1 are functional entities whose physical implementation may vary. Usually, the mobile services switching centre 102 and visitor location register 104 form one physical device, and the home location register 114, equipment identity register 112 and authentication centre 116 form a second physical device.

A serving GPRS support node (SGSN) 118 is the centre point of the packet-switched side of the core network 100. The main task of the serving GPRS support node 118 is to transmit and receive packets with the user equipment 170 supporting packet-switched transmission by using the radio access network 130 or the base transceiver station system 160. The serving GPRS support node 118 contains subscriber and location information related to the user equipment 170.

A gateway GPRS support node (GGSN) 120 is the packet-switched side counterpart to the gateway mobile services switching centre 110 of the circuit-switched side with the exception, however, that the gateway GPRS support node 120 must also be capable of routing traffic from the core network 100 to external networks 182, whereas the gateway mobile services switching centre 110 only routes incoming traffic. In our example, the external networks 182 are represented by the Internet.

The base transceiver station system 160 comprises a base transceiver station controller (BSC) 166 and base transceiver stations (BTS) 162, 164. The base transceiver station controller 166 controls the base transceiver station 162, 164. In principle, the aim is that the devices implementing the radio path and their functions reside in the base transceiver station 162, 164, and the control devices reside in the base transceiver station controller 166.

The base transceiver station controller 166 takes care of the following tasks, for instance: radio resource management of the base transceiver station 162, 164, intercell handovers, frequency control, i.e. frequency allocation to the base transceiver stations 162, 164, management of frequency hopping sequences, time delay measurement on the uplink, implementation of the operation and maintenance interface, and power control.

The base transceiver station 162, 164 contains at least one transceiver which provides one carrier, i.e. eight time slots, i.e. eight physical channels. Typically one base transceiver station 162, 164 serves one cell, but it is also possible to have a solution in which one base transceiver station 162, 164 serves several sectored cells. The diameter of a cell can vary from a few meters to tens of kilometers. The base transceiver station 162, 164 also comprises a transcoder which converts the speech coding format used in the radio system to that used in the public switched telephone network and vice versa. In practice, the transcoder is, however, physically located in the mobile services switching centre 102. The tasks of the base transceiver station 162, 164 include: calculation of timing advance (TA), uplink measurements, channel coding, encryption, decryption, and frequency hopping.

The radio access network 130 is made up of radio network subsystems 140, 150. Each radio network subsystem 140, 150 is made up of radio network controllers 146, 156 and B nodes 142, 144, 152, 154. A B node is rather an abstract concept, and often the term ‘base transceiver station’ is used instead.

Operationally, the radio network controller 140, 150 corresponds approximately to the base transceiver station controller 166 of the GSM system, and the B node 142, 144, 152, 154 corresponds approximately to the base transceiver station 162, 164 of the GSM system. Solutions also exist in which the same device is both the base transceiver station and the B node, i.e. said device is capable of implementing both the TDMA and WCDMA radio interface simultaneously.

The user equipment 170 comprises two parts: mobile equipment (ME) 172 and UMTS subscriber identity module (USIM) 174. The GSM system naturally uses its own identity module. The user equipment 170 contains at least one transceiver for establishing a radio link to the radio access network 130 or base transceiver station system 160. The user equipment 170 can contain at least two different subscriber identity modules. In addition, the user equipment 170 contains an antenna, a user interface and a battery. Today, there are different types of user equipment 170, for instance equipment installed in cars and portable equipment.

USIM 174 contains information related to the user and information related to information security in particular, for instance an encryption algorithm.

Finally, the interfaces between different network elements shown in FIG. 1 are listed in Table 1. In UMTS, the most important interfaces are the Iu interface between the core network and the radio access network, which is divided into the interface IuCS on the circuit-switched side and the interface IuPS on the packet-switched side, and the Uu interface between the radio access network and the user equipment. In GSM, the most important interfaces are the A interface between the base transceiver station controller and the mobile services switching centre, the Gb interface between the base transceiver station controller and the serving GPRS support node, and the Um interface between the base transceiver station and the user equipment. The interface defines what kind of messages different network elements can use in communicating with each other. The aim is to provide a radio system in which the network elements of different manufacturers interwork so well as to provide an effective radio system. In practice, some of the interfaces are, however, vendor-dependent.

| | Between |
|---|---|
| Interface | network elements |
| Uu | UE-UTRAN |
| lu | UTRAN-CN |
| luCS | UTRAN-MSC |
| luPS | UTRAN-SGSN |
| Cu | ME-USIM |
| lur | RNC-RNC |
| lub | RNC-B |
| A | BSS-MSC |
| Gb | BSC-SGSN |
| A-bis | BSC-BTS |
| Urn | BTS-UE |
| B | MSC-VLR |
| E | MSC-MSC |
| D | MSC-HLR |
| F | MSC-EIR |
| Gs | MSC-SGSN |
| PSTN | MSC-GMSC |
| PSTN | GMSC-PLMN/PSTN |
| G | VLR-VLR |
| H | HLR-AUC |
| Gc | HLR-GGSN |
| Gr | HLR-SGSN |
| Gf | EIR-SGSN |
| Gn | SGSN-GGSN |
| Gi | GGSN-INTERNET |

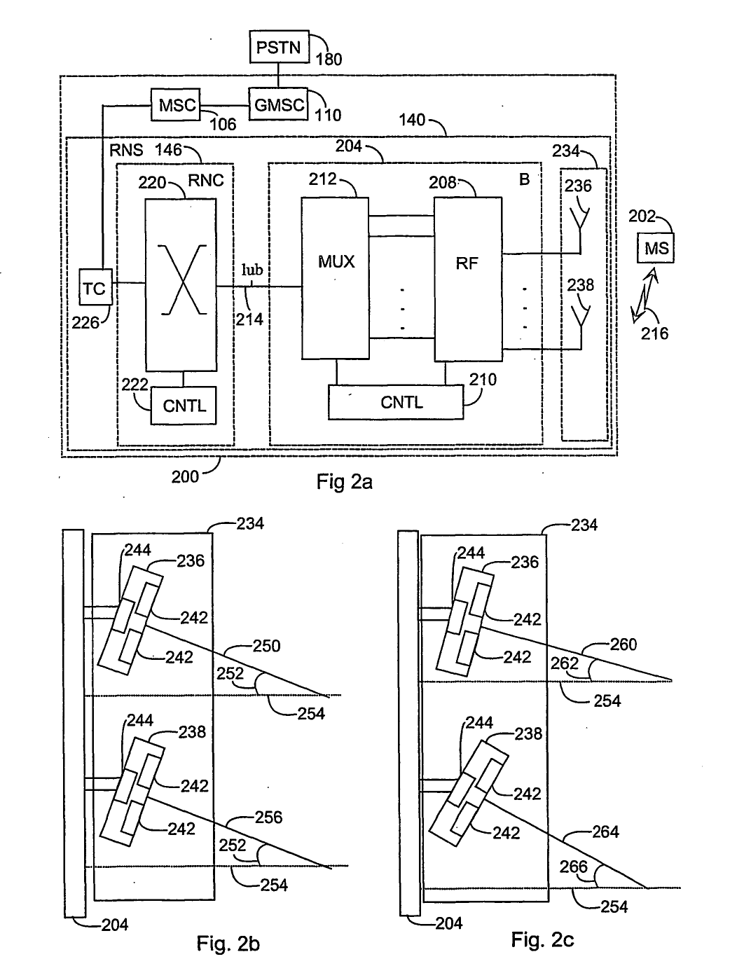

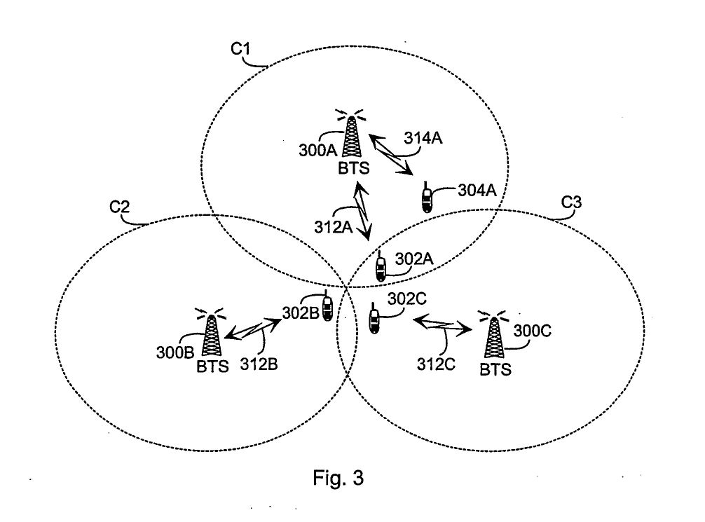

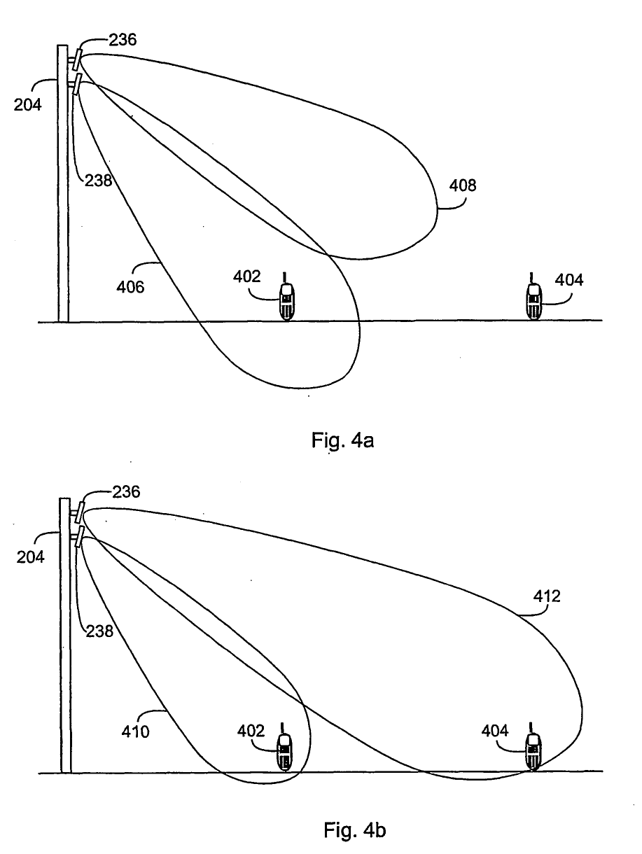

The illustration of FIG. 1 is at rather a general level, so that FIG. 2a shows a more detailed example of a cellular radio system. FIG. 2a contains only the most essential blocks, but it is obvious to a person skilled in the art that a conventional cellular radio network also comprises other functions and structures, there being no need to explain them in greater detail in this context. The details of the cellular radio system may deviate from what is illustrated in FIG. 2, but such differences are of no significance to the invention.

FIG. 2a shows a mobile services switching centre 106, a gateway mobile services switching centre 110 attending to the connections of the mobile telephone system to the outside world, here to a public switched telephone network 180, as well as a network part 200 and terminals 202.

A cellular radio network typically comprises a fixed network infrastructure, i.e. network part 200, for instance a base transceiver station, and terminals 202, which can be fixedly positioned, positioned in a vehicle or portable terminals, such as mobile telephones or portable computers, which allow connection to a radio telecommunications system. The network part 200 comprises base transceiver stations 204. A base transceiver station corresponds to the B node of the preceding figure. Several base transceiver stations 204 are, in turn, controlled by a radio network controller 146 connected to them, comprising a group switching field 220 and a control unit 222. The group switching field 220 is used for switching speech and data and for connecting signalling circuits. The control unit 222, in turn, performs speech control, mobility management, collection of statistical data, signalling and resource control and management.

The radio network subsystem 140, which is formed by the base transceiver station 204 and the radio network controller 146, further comprises a transcoder 226, which converts different digital speech coding formats used between the public switched telephone network and the mobile telephone network to be compatible with each other, for instance from the fixed network format into another format of the cellular radio network, and vice versa. The transcoder 226 is usually positioned as close to the mobile services switching centre 106 as possible, because speech can thus be transferred in the cellular radio network format between the transcoder 226 and the radio network controller 146, saving transfer capacity.

The base transceiver station 204 further comprises a multiplexer unit 212, transceivers 208 and a control unit 210 controlling the operation of the transceiver 208 and the multiplexer 212. With the multiplexer 212, the traffic and control channels used by several transceivers 208 are positioned on one transmission link 214. The transmission link 214 forms the interface lub.

The transceivers 208 of the base transceiver station 204 communicate with an antenna array 234 including at least two antennas 236, 238. At least one radio link 216 to at least one terminal 202 is implemented with the antenna array 234. In at least one radio link 216, the structure of the frames to be transferred is defined system-specifically, and it is called an air interface Uu.

FIG. 2b shows the structure of the antenna array 234 of the base transceiver station 204. Each base transceiver station 204 comprises at least one antenna array 234, which, in turn, comprises at least two antennas 236, 238. Each antenna 236, 238 comprises at least one antenna element 242, the distance of which from the rest of the antenna elements 242 is typically 0.5 to 1 times the length of the carrier wave used by the base transceiver station 204. The electromagnetic field of each antenna 236, 238 forms a beam structure which can be shaped, directed and polarized by appropriately configuring at least one of its antenna elements 242 and by controlling the power and phase supplied to at least one antenna element 242. Hereby, the antennas 236, 238 are typically adaptive. The control and phasing of the antenna elements can be implemented in the transceiver 208 of the base transceiver station 204, for example.

FIGS. 2b and 2c show the antenna structure of at least two antennas 236, 238 of the base transceiver station 204 and the vertical direction of the beam structure formed by the antennas 236, 238, as well as the quantities relating to the direction. The vertical direction of the beam structure can be defined by a quantity 250, 256, 260, 264 characterizing the physical orientation of the beam structure, such as by the direction 252, 262, 266 of the maximum amplification of an antenna beam relative to a reference 254. The direction 252, 262, 266 of the antenna beams can be defined as the elevation angle 252 of the maximum amplification of the beam, for example. To clarify the explanation, the quantities 250, 256, 260, 264 are called antenna beams 250, 256, 260, 264. In addition to the configuration of said at least one antenna element 242 and the signal manipulation, such as phasing, of at least one antenna element, antenna beams 250, 256, 260, 264 can be directed vertically by turning the antennas 236, 238 physically in a desired direction, whereby the direction 252, 262, 266 changes.

The directions 252, 262, 266 can be implemented as fixed direction, which can be based on field measurements, for example. Physical direction can also be performed dynamically, in which case the direction 252, 262, 266 of the antennas 236, 238 is changed electronically or hydraulically, for example. The physical vertical direction 252, 262, 266 of the antenna beams 250, 256, 260, 266 can be implemented in a means 244 comprising the required mechanisms and, for instance, stepping motors with control units. In physical direction, the antenna beam pattern remains in practice unchanged.

In a solution according to the prior art, illustrated by FIG. 2b, the vertical directions 252 of the antenna beams 250, 256 remain the same, irrespective of the value of the direction 252.

FIG. 2c shows a solution according to a preferred embodiment of the invention for directing the antenna beams 260, 264. In this case, the antenna beams 260, 264 are directed in such a way that their directions 262, 266 relative to the reference 254 are different.

In a preferred embodiment of the invention, the ratio of the signal powers of at least two antennas 236, 238 of the antenna array 234 located in the base transceiver station 204 and arranged in accordance with FIG. 2c can be controlled. The ratios of the signal powers used in each base transceiver station 204 are preferably shown by means of base-station-specific weighting coefficients. Thus, the ratio of the signal powers is a function of the weighting coefficient. The ratio of the signal powers, i.e. weighting, can be controlled cell-specifically and user-specifically.

In cell-specific weighting, the signal powers directed by the antennas 236, 238 of the antenna array 234 at the different terminals 202 is not affected, but the transmission power of each antenna 236, 238 is controlled by weighting the signals directed at the antennas 236, 238.

In user-specific weighting, the powers of the signals directed by the antennas 236, 238 of the antenna array 234 at the different terminals 202 is affected, whereby the transmission power of each antenna 236, 238 can change.

The cell-specific and user-specific weighting of the signal power can also be performed simultaneously, in which case the signal directed at the desired terminal 202 can be transmitted with a desired power from any desired antenna 236, 238 of the antenna array 234.

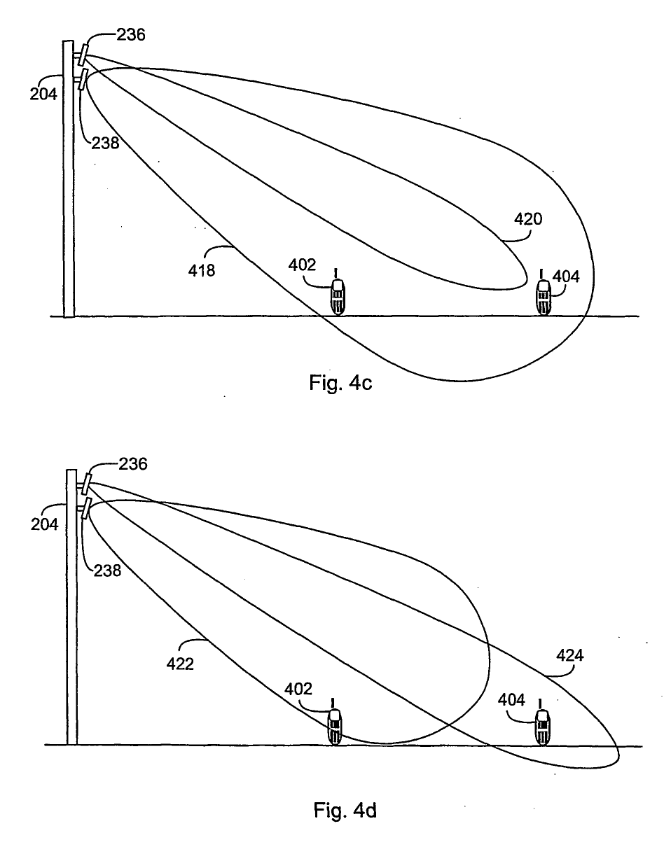

FIG. 3 shows a simplified illustration of a cellular radio system comprising base transceiver stations 300A to 300C, and one or more terminals 302A, 304A, 302B and 302C, which are, for example, mobile phones or portable computer equipment provided with a radio link. The base transceiver stations of FIG. 3 comprise the base transceiver station structure 204 shown in FIG. 2a and the antenna array 234. The coverage areas, i.e. cells, of each base transceiver station 300A to 300C are denoted with C1 to C3 in the figure. In practice, the cells overlap partly, such as in the example of the figure, where the cell C2 has partial overlapping with the cells C1 and C3. In real cellular systems, the shape of the cells usually deviates from the regular ellipse shown, for instance because of ground obstacles.

FIG. 3 also shows bi-directional radio connections 312A, 314A, 312B and 312C between the terminals 302A, 304A, 302B and 302C and the base transceiver stations 300A, 300B and 300C. Transmission from the base transceiver station 300A towards the terminal 302A is called downlink DL. Transmission in the opposite direction is called uplink UL.

The above-mentioned embodiments of signal weighting can be formulated mathematically in the following way. Let us say that the number of M antennas 236, 238 in the antenna array 234 is M≧2 and the number of links 216 maintained by the base transceiver station 204 is K. Vector X indicates signals by different users, while vector Y indicates weighting signals to the different antennas 236. Hereby,

X=(x₁, x₂, . . . , x_{K})^{T}

Y=(y₁, y₂, . . . , y_{M})^{T}

wherein superscript T refers to transposing of a vector or matrix. The following equation is applied to vectors X and Y:

Y=U·(VX)

wherein matrix U contains cell-specific weights selected by the radio network controller 146 or the base transceiver station 204 for the different antennas 236, 238, and matrix V contains user-specific weights selected by the radio network controller 146 or the base transceiver station 204 for the different antennas 236, 238. Matrices U and V are defined as follows:

$$U = ( \begin{matrix}{u}_{1} & 0 & ⋯ & 0 \\ 0 & {u}_{2} & ⋯ & 0 \\ ⋮ & ⋮ & ⋰ & ⋮ \\ 0 & 0 & ⋯ & {u}_{M}\end{matrix} ) , V = ( \begin{matrix}{v}_{1 , 1} & {v}_{1 , 2} & ⋯ & {v}_{1 , K} \\ {v}_{2 , 1} & {v}_{2 , 2} & ⋯ & {v}_{2 , K} \\ ⋮ & ⋮ & ⋰ & ⋮ \\ {v}_{M , 1} & {v}_{M , 2} & ⋯ & {v}_{M , K}\end{matrix} ) .$$

Both the cell-specific weights and user-specific weights are relative and thus normalized as one, in other words the following is applied:

$${\sum }_{m = 1}^{M} {u}_{m}^{2} = 1 , {\sum }_{m = 1}^{M} {v}_{m , k}^{2} = 1.$$

Let us next study the criteria on the basis of which the elements of matrices U and V are determined, taking under observation cell C1 of FIG. 3, whose neighbouring cells are C2 and C3. The users are the terminals in the area of the cells. In a preferred embodiment of the invention, the weights shown by matrix U are selected in the controller 146, the selection of the weights being based on the capacity requirement of cell C1 under observation and its neighbouring cells C2, C3. Thus, parameters affecting the selection are the interference between cells C1 to C3 and the changing capacity requirement of individual cells C1, C2, C3. Further, the weights shown by matrix V are selected in the base transceiver station 204 of cell C1 under observation according to the needs of cell C1 at that moment. Parameters affecting these needs include, for instance, distribution of users in the area of cell C1 and the capacity requirement of individual users.

In a possible example case, the terminal 302A is in UL connection 312A with the base transceiver station 300A and located in the edge area of the base transceiver station cell C1 in the vicinity of the adjacent cell C2. Correspondingly, the terminal 302B is in connection 312B with the base transceiver station 300B and located at the edge of cell C2 in the vicinity of cell C1. Thus, the signal transmitted by the terminal 302A is mixed with the signal 312B received by the base transceiver station 300B from the terminal 302B, which is seen as radio interference in the base transceiver station 300B. The magnitude of the radio interference can be measured by for instance an SIR (Signal to Interference Ratio) estimate, which is determined in the processor of the base transceiver station 300B as a software application, for example. On the basis of the magnitude of the radio interference, the radio network controller 146 or the base transceiver station 300A determines the weighting coefficients of the base transceiver station 300A, on the basis of which the base transceiver station 300A attempts to improve the radio link 312A, whereby the base transceiver station 300A can send to the terminal 302A a request to decrease the transmission power. The weighting coefficients can also be determined in such a way that the connection between the base transceiver station 300A and the terminal 302A is deteriorated, whereby the terminal moves to the operating area of the base transceiver station 300B.

In another exemplary case, the base transceiver station 300A is in DL connection with the terminal 302A, whereby the DL connection 312B between the base transceiver station 300B and the terminal 302B may be disturbed. In such a case, in the solution according to the invention, the terminal 302B determines the magnitude of the radio interference to which it is subjected, for instance by means of an SIR estimate, which is determined in the processor of the terminal 302B by software and on the basis of which the weighting coefficients determining the signal power of the base transceiver station 300A are defined. Thus, the base transceiver station 300A can allocate some of its signal power to the terminal 302A, whereby the interference level of the terminal 302B is lowered. Alternatively, the base transceiver station allocates its signal power in such a way that the terminal 302A moves to the area of the base transceiver station 300B.

In an embodiment of the invention, determination of the weighting coefficients can be based on the magnitudes of the signals 312A and 314A of the base transceiver station 300A, received from the terminals 302A and 304A. In such a case, each antenna 236, 238 of the base transceiver station 300A determines the magnitude of the signals it has received from each terminal 302A, 304A as well as the ratios of the magnitudes, and the weighting coefficients from the signal magnitude ratios. The transmission power of the base transceiver station to the terminals 302A and 304A is determined directly from the defined weighting coefficients.

Determination of the weighting coefficients can also be based on the data transmission capacity of the links 312A and 312B implemented in the radio system. In this case, the weighting coefficients of different base transceiver stations are determined in such a way that the the data transfer performance of the whole radio system or some parts of it is optimized.

Determination of the weighting coefficients can also be based on the number of lost links detected in the radio system.

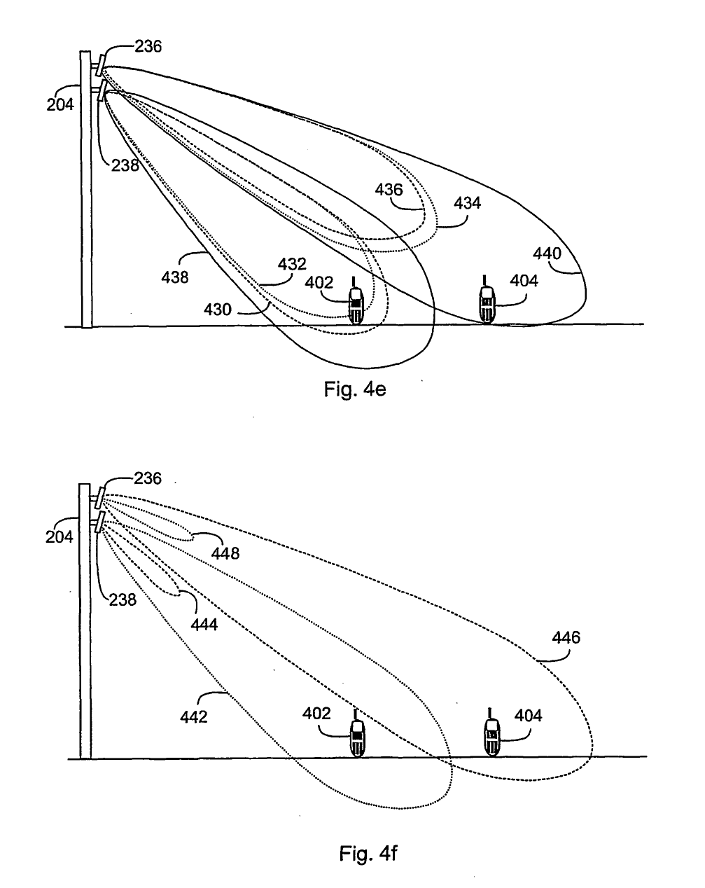

FIGS. 4a to 4f show examples of how preferred embodiments according to the invention for weighting antenna signals can be seen in a beam structure formed by at least two antennas 236, 238 of the antenna array 234 of the base transceiver station 204. The terminals 402 and 404 are shown in the figure to clarify the explanation, and they can be rather understood as cell areas functioning as radio signal sources or objects.

The base transceiver station of FIG. 4a comprises at least one antenna array 234, each of which comprises at least two antennas 236, 238. The antenna configuration of FIG. 4a is shown in FIG. 2c. At least two antennas 236, 238 form at least two beams 406, 408. Each of the at least two antennas 236, 238 forms at least one beam 406 and 408, which characterize the signal power outgoing from or incoming to each antenna 236, 238. Each antenna 236, 238 is arranged in such a way that the antenna beams 406, 408 formed by them deviate from each other vertically in such a way that with weighting of the signal power of individual antennas 236, 238 the desired effect is achieved for the operation of the radio system. In accordance with FIG. 4a, the antennas 236, 238 are arranged in such a way, for example, that the vertical directions of the beams 406, 408 formed by at least two antennas 236, 238 positioned in the same antenna array 234 deviate from each other relative to the same reference. In a second preferred embodiment shown in FIG. 4d, the antennas 236, 238 are arranged to form antenna beams 418, 420 having vertically different shapes. The arrangement can also comprise polarization of the antennas 236, 238. The antennas 236, 238 can also be arranged in such a way that the antenna beams formed by them deviate from each other as regards more than one above-mentioned property. For instance, two beams can deviate from each other as regards their vertical directions, vertical shapes and polarization.

In the case of FIG. 4a, each antenna 236, 238 is arranged to form beams 406, 408 deviating from each other as regards their vertical directions. In this exemplary case, the terminal 402 is well within the coverage area of the base transceiver station 204, whereas the terminal 404 is at the edge of or outside the coverage area of the base transceiver station 204. Performing cell-specific weighting of the signal 408 leads to the case of FIG. 4b, where the signal power 412 required by the terminal 404 is realized and the terminal 404 is thus located within the coverage area of the base transceiver station 204. At the same time, the weight of the signal 406 directed at the terminal 402 decreases, whereby the signal 406 is modified into a signal 410, which fulfils the signal power required by the terminal 402.

In the embodiment according to FIG. 4a, the vertical direction information on the antenna beams of the base transceiver station 204 can also be utilized for locating the terminals 402, 404 in the area of the base transceiver station 204. In a preferred embodiment of the invention, the base transceiver station 204 determines the signal power received by the at least two antennas 236, 238 from at least one terminal 402, 404. The measurement of the signal power can also be performed as the time average of 100 milliseconds, for instance. When the directions 260, 264 of the antennas 236, 238 of the base station 204 are known, the direction of the terminal relative to the common reference of the directional angles 260, 264 can be calculated for instance as the weighted average of the directional angles 260, 264 when the signal power of the terminal 402, 404 determined by the antennas 236, 238 is used as weights. If the elevation angle of the beams 260, 264 is used as the directional measure, the elevation angle of the terminal can be determined by means of the above method.

In the case of 4c, the antennas of the base transceiver station 204 are arranged to form antenna beams 418, 420 having similar vertical directions but different vertical shapes. FIG. 4c shows a situation where the terminal 404 has greater signal power than the terminal 402 and is thus outside the coverage area of the base transceiver station. Hence, the cell-specific weight of the signal power 420 is increased, while, at the same time, the cell-specific weight of the signal power 418 decreases. This results in the beam structure according to FIG. 4d, in which the signal 418 has been modified into a signal 422, and the signal 420 has been modified into a signal 424. Thus, the power requirement of the terminals in the area of the base transceiver station 204 is nearly optimized.

FIGS. 4e and 4f show the effect of the user-specific weighting on the signal power between the base transceiver station 204 and the terminals 402, 404 when the vertical directions of the antenna beams deviate from each other, but corresponding examples can also be presented in a case where the vertical shapes of the antenna beams are different. In FIG. 4e, the antennas 236, 238 form a beam structure where user-specific beams 430, 432 form together a total beam 438 and user-specific beams 434, 436 form correspondingly a total beam 440. The link specific-beams 432, 434 represent the signal of the base transceiver station 204 to the terminal 402. The user-specific beams 430, 436 correspondingly represent the signal of the base transceiver station 204 to the terminal 404. The total beams 438, 440 are here defined as a level surface of the electromagnetic field, for example, whereas the user-specific beams 430, 432, 434, 436 represent the magnitude of the signal directed at each terminal 402, 404. In FIG. 4e, the terminals 402, 404 are in the coverage area of the base transceiver station 204, but signals directed at the different terminals 402, 404 disturb each other. Performing user-specific weighting for the antenna signals 430, 432, 434, 436 results in the beam structure according to FIG. 4e. Here, the weight of the signal 432 directed at the terminal 402 of the antenna 238 is increased, whereby the signal 432 is modified into a signal 442. At the same time, the weight of the signal 430 directed at the terminal 404 from the antenna 238 is reduced, whereby the signal 430 is modified into a signal 444. At the same time, the weight of the signal 436 directed at the terminal 404 from the antenna 236 is increased, whereby the signal 436 is modified into a signal 446. Simultaneously, the weight of the signal 434 directed at the terminal 402 from the antenna 236 is reduced, whereby the signal 434 is modified into a signal 448. As a result of the weighting, the signal directed at each terminal 402, 404 has intensified and the magnitude of multiple access interference, for instance, has clearly decreased.

Although the invention has been described above with reference to the example according to the attached drawings, it is obvious that the invention is not confined thereto but can be modified in a plurality of ways within the inventive idea presented in the attached claims.

1. A method of controlling a radio system in a base transceiver station (204), in which base transceiver station (204) at least one antenna array (234) is formed, which comprises at least two antennas (236, 238) for transmitting and receiving a signal, comprising:
arranging at least two antennas of each antenna array (234) in such a way that antenna beams formed by the at least two antennas (236, 238) deviate vertically from each other what it comes to at least one property thereof;
characterized by controlling the ratio of the signal powers transmitted via the different antennas (236, 238) of each antenna array (234).

2. A method according to claim 1, characterized by
controlling the ratio of the signal powers cell-specifically.

3. A method according to claim 1, characterized by
controlling the ratio of the signal powers user-specifically.

4. A method according to claim 1, characterized by
controlling the ratio of the signal powers by means of weighting coefficients.

5. A method according to claim 1, characterized by
one or more base transceiver stations (300B) of the radio system determining the magnitude of radio interference caused by one or more terminals (302A) located in the areas of one or more base transceiver stations (300A), the ratios of base-station-specific signal powers of one or more base transceiver stations (300A) being controlled on the basis of the magnitude of radio interference.

6. A method according to claim 1, characterized by
one or more terminals (302B) located in the transmission area of one or more base transceiver stations (300B) determining the magnitude of radio interference caused by one or more base transceiver stations (300A), the ratios of base-station-specific signal powers of one or more base transceiver stations (300A) being controlled on the basis of the magnitude of radio interference.

7. A method according to claim 1, characterized by
the base transceiver station (204) receiving a signal from a terminal (202), measuring the power incoming from the different antennas (236, 238) and controlling the ratios of the signal powers transmitted via the different antennas (236, 238).

8. A method according to claim 1, characterized by
determining the capacity gain of the radio system achieved with the ratios of the signal powers of one or more base transceiver stations (204), on the basis of which capacity gain the ratios of the signal powers are controlled.

9. A method according to claim 1, characterized by
determining the number of one or more links (216) lost in the area of one or more base transceiver stations (204), on the basis of which number the ratios of the signal powers are controlled.

10. A method according to claim 4, characterized by
the weighting coefficients of one or more base transceiver stations (300A) being based on the data transmission capacity required (302A) by one or more terminals located in the transmission area of each base transceiver station (300A).

11. A method according to claim 5 or 6, characterized by
the magnitude of radio interference being determined by an SIR estimate.

12. A method according to claim 1, characterized by
the antenna beams formed by antennas (236, 238) deviating vertically from each other in such a way that the vertical directions (262, 266) of the antenna beams are different from each other.

13. A method according to claim 12, characterized by
the vertical directions (262, 266) of the antenna beams being controlled by turning the antennas (236, 238) physically.

14. A method according to claim 1, characterized by
the vertical beam patterns of the antenna beams formed by the antennas (236, 238) being different from each other.

15. A method according to claims 12 and 14, characterized by
the polarizations of the antenna beams formed by the antennas (236, 238) being different from each other.

16. A method according to claim 1, characterized by
the antennas (236, 238) being adaptive antennas.

17. A method according to claim 1, characterized by
the radio system being a WCDMA system.

18. A method according to claim 1, characterized by
the radio system being a GSM/EDGE system.

19. A method according to claim 1, characterized by
determining the magnitude of a signal (216) transmitted from one or more terminals (202) to the antennas (236, 238) of the antenna array (234) of the base transceiver station (204), and determining the location of the terminal (202), utilizing the magnitude of the signal (216) and the vertical direction information (262, 266) on the antenna beams.

20. A radio system comprising at least one terminal (202) and at least one base transceiver station (204), the base transceiver station (204) comprising at least one antenna array (234), which antenna array (234) comprises at least two antennas (236, 238), the antennas (236, 238) being arranged to form antenna beams deviating vertically from each other what it comes to at least one property thereof;
characterized in that
the radio system comprises means (146, 204) for controlling the ratio of the signal powers transmitted via the different antennas (236, 238) of each antenna array (234).

21. A radio system according to claim 20, characterized in that
the means (146, 204) is arranged to control the ratio of the signal powers cell-specifically.

22. A radio system according to claim 20, characterized in that
the means (146, 204) are arranged to control the ratio of the signal powers user-specifically.

23. A radio system according to claim 20, characterized in that
the means (146, 204) are arranged to control the ratio of the signal powers by means of weighting coefficients.

24. A radio system according to claim 20, characterized in that
one or more base transceiver stations (300B) of the radio system are arranged to determine the magnitude of radio interference caused by at least one terminal (302A) located in the area of at least one base transceiver station (300A) and to transmit the magnitude of radio interference to the base transceiver station, to the means (146, 204), which means (146, 204) is arranged to control the base-station specific ratios of the signal powers of at least one base transceiver station (300A) on the basis of the magnitude of radio interference.

25. A radio system according to claim 24, characterized in that
the base transceiver station (300B) is arranged to determine the magnitude of radio interference from an SIR estimate.

26. A radio system according to claim 20, characterized in that
at least one terminal (302B) located in the transmission area of one or more base transceiver stations (300B) is arranged to determine the magnitude of radio interference caused by at least one base transceiver station (300A) and to transmit the magnitude of radio interference to the means (146, 204), which means (146, 204) is arranged to control the base-station-specific ratios of the signal powers of one or more base transceiver stations (300A) on the basis of the radio interference.

27. A radio system according to claim 26, characterized in that
the terminal (302B) is arranged to determine the magnitude of radio interference from an SIR estimate.

28. A radio system according to claim 20, characterized in that
the means (146, 204) are arranged to control the ratios of the signal powers transmitted via the antennas (236, 238) by using the signal power received by the antennas (238, 238) of the base transceiver station (204) from the terminal (202).

29. A radio system according to claim 20, characterized in that
the means (146, 204) are arranged to control the ratio of the signal powers by using the capacity gain of the radio system achieved with the ratios of the signal powers of one or more base transceiver stations (204).

30. A radio system according to claim 20, characterized in that
the means (146, 204) are arranged to control the ratios of the signal powers on the basis of the number of at least one link (216) lost in the area of at least one base transceiver station (204).

31. A radio system according to claim 23, characterized in that
the means (146, 204) are arranged to control the weighting coefficients of one more base transceiver stations (300A), the weighting coefficients being based on the data transmission capacity required (302A) by at least one terminal located in the transmission area of each base transceiver station (300A).

32. A radio system according to claim 20, characterized in that
the radio system comprises means (208, 244) for controlling vertical directions (262, 266) of the antenna beams of the antennas (236, 238).

33. A radio system according to claim 32, characterized in that
the radio system comprises means (244) for controlling the antennas (236, 238) physically.

34. A radio system according to claim 20, characterized in that
the radio system comprises means (208) for controlling the vertical shape of the antenna beams formed by the antennas (236, 238).

35. A radio system according to claim 32 and 34, characterized in that
the radio system comprises means (208) for controlling polarization of the antenna beams formed by the antennas (236, 238).

36. A radio system according to claim 20, characterized in that
the antenna array (234) of the radio system comprises adaptive antennas.

37. A radio system according to claim 20, characterized in that
the means (146, 204) is arranged to determine the location of the at least one terminal (202), utilizing the magnitude of the signal (216) transmitted from the terminal (202) to the antennas (236, 238) of the antenna array (234) of the base transceiver station (204), and vertical direction information (262, 266) on the antenna beams of the base transceiver station (204).
